(19) United States
(12) Patent Application Publication
(10) Pub. No.: US 2018/0094584 A1
(43) Pub. Date: Apr. 5, 2018

(54) COOLING OF THE OIL CIRCUIT OF A TURBINE ENGINE

(71) Applicant: Safran Aircraft Engines, Paris (FR)

(72) Inventor: Sebastien Chalaud, Moissy-Cramayel (FR)

(73) Assignee: Safran Aircraft Engines, Paris (FR)

(21) Appl. No.: 15/563,257

(22) PCT Filed: Apr. 1, 2016
(86) PCT No.: PCT/FR2016/050745

§ 371 Date: Sep. 29, 2017

(30) Foreign Application Priority Data
Apr. 3, 2015 (FR) 1552920

(51) Int. Cl. F02C 7/14; F02C 7/06; F01M 5/00; F02C 7/18; F02C 7/224; F25B 9/02; F25B 41/04

(52) U.S. Cl. CPC F02C 7/14; F02C 7/06; F01M 5/002; F01D 25/18; F02C 7/224; F25B 9/02; F25B 41/04; F02C 7/185

(57) ABSTRACT

The invention relates to a turbine engine, such as a turbojet engine or a turboprop engine of an aeroplane, including at least one oil circuit (8) and cooling means (16) for cooling the oil of said circuit (8), the cooling means (16) including a refrigerant circuit (17) provided with a first heat exchanger (18) capable of exchanging heat between the refrigerant and the air and forming a condenser, a second heat exchanger (19) capable of exchanging heat between the refrigerant and the oil of the oil circuit and forming an evaporator, a pressure reducer (20), a compressor (21) and first regulator means (31) capable of regulating the pressure of the refrigerant entering the first exchanger (18).

The present invention relates to a turbine engine, such as a turbojet engine or a turboprop engine of an aeroplane, including at least one oil circuit and means for cooling the oil of said circuit.

In a known way, a turbine engine comprises an oil circuit for lubricating and cooling systems, in particular such as anti-friction bearings or gear members, and likewise comprises a fuel circuit supplying injectors mounted in a combustion chamber.

It is known to connect the oil and fuel circuits by heat exchangers in order to avoid excessive heating of the lubricating oil, the oil being cooled by exchanging heat with the fuel.

For this purpose, a fuel/oil heat exchanger is used, arranged in the oil and fuel circuits downstream or upstream from one or more oil/air heat exchangers mounted in the oil circuit. The oil/air heat exchanger is crossed or swept by a flow of air coming from outside or inside the turbine engine.

The oil/air heat exchanger is necessary for cooling the oil when, for certain operating points of the turbine engine, the fuel/oil heat exchanger does not provide sufficient cooling of the oil.

Other solutions are also known from the prior art, in particular such as the use of a thermostatic valve in a bypass line at the intake of the oil/air heat exchanger or even the use of dampers of the air supply.

Applications FR 2 951 228, FR 1 061 138 and FR 1 157 953 by the applicant describe architectures of oil and fuel circuits in a turbine engine.

The oil/air heat exchanger is, for example, of the surface cooling type, in other words, it comprises oil lines swept by a flow of cold air coming from a bypass air flow of the turbojet engine referred to as secondary air flow. Such an exchanger is, for example, recessed in a wall of the by-pass duct, directly downstream from the fan.

The oil/air heat exchanger can also be of the plate type and crossed by an air flow collected in the secondary air flow and re-injected at the outlet into same.

Existing exchangers have relatively low efficiency, which forces the use of relatively bulky exchangers. And yet, since these are placed in the secondary air flow, they create aerodynamic disruptions that increase with their size, which is detrimental to the overall efficiency of the turbine engine.

In order to solve this drawback, patent application FR 2 993 610, in the name of the applicant, proposes a turbine engine, such as a turbojet engine or a turboprop engine of an aeroplane, including at least one oil circuit and means for cooling the oil of said circuit including a refrigerant circuit provided with a first heat exchanger capable of exchanging heat between the refrigerant and the air and forming a condenser, a second heat exchanger capable of exchanging heat between the refrigerant and the oil of the oil circuit and forming an evaporator, a pressure reducer mounted downstream from the first exchanger and upstream from the second exchanger, in the refrigerant flow direction, and a compressor mounted downstream from the second exchanger and upstream from the first exchanger.

In this way, the oil circuit is no longer cooled by means of a simple air/oil heat exchanger, but instead by means of a thermodynamic system such as a heat pump.

In this system, the heat is collected from the oil by the evaporator, and then transferred to the air by the condenser.

Such a thermodynamic system offers high efficiency, which makes it possible in particular to limit the size of the exchanger between the air and the refrigerant so as not to affect the overall efficiency of the turbine engine.

It is necessary to further increase the overall efficiency of the turbine engine.

For this purpose, the invention proposes a turbine engine, such as a turbojet engine or a turboprop engine of an aeroplane, including at least one oil circuit and means for cooling the oil of said circuit, the cooling means including a refrigerant circuit provided with a first heat exchanger capable of exchanging heat between the refrigerant and the air and forming a condenser, a second heat exchanger capable of exchanging heat between the refrigerant and the oil of the oil circuit and forming an evaporator, a pressure reducer mounted downstream from the first exchanger and upstream from the second exchanger, in the refrigerant flow direction, and a compressor mounted downstream from the second exchanger and upstream from the first exchanger, characterised in that the cooling means include first regulator means capable of regulating the pressure of the refrigerant entering the first exchanger.

In this way, it is possible to vary the pressure of the refrigerant passing through the first heat exchanger—i.e. the condenser—in particular as a function of the flight conditions or external conditions.

Therefore, in so-called hot conditions, when the temperature of the outside air is hotter, it is necessary to increase the pressure of the refrigerant passing through the condenser, in order to discharge enough heat energy and ensure sufficient heating of the oil of the corresponding circuit. This operating mode, which represents a small portion of the operating or flight scenarios, is relatively energy-intensive since it requires supplying enough power to the compressor to be able to reach the necessary power at the intake of the first exchanger.

Conversely, in most operating or flight scenarios, when the outside air temperature is lower, the pressure of the refrigerant passing through the condenser can be reduced while ensuring sufficient cooling of the oil. In this case, it is possible to reduce the power consumed by the compressor and thus to improve the overall efficiency of the turbine engine.

The turbine engine can also include second regulator means capable of regulating the flow of refrigerant entering the first exchanger.

The flow of refrigerant is mainly a function of the pressure at the intake of the first heat exchanger.

According to one embodiment of the invention, the compressor is a twin-screw supercharger.

In this case, the first regulator means include a mobile slide with adjustable position relative to the screws of the supercharger, the pressure of the refrigerant at the outlet of the compressor depending on the position of said slide, the first regulator means including means for controlling the position of said slide.

Such a twin-screw supercharger provided with a mobile slide is known, in particular, from documents FR 2 501 799, EP 0 162 157 and U.S. Pat. No. 7,588,430, for other uses.

Furthermore, the second regulator means can include means capable of controlling the speed of rotation of the screws of the supercharger.

Indeed, in the case of a supercharger, the outlet flow of said compressor is dependent on the speed of rotation of the screws.

According to another embodiment of the invention, the compressor is a centrifugal compressor including a rotor of which the speed of rotation determines the pressure of the refrigerant at the outlet of the compressor.

In this case, the first regulator means include means for controlling the speed of rotation of the rotor.

Indeed, in the case of a supercharger, the outlet pressure of said compressor is dependent on the speed of rotation of the rotor.

Furthermore, the second regulator means include a variable-section diaphragm located downstream from said centrifugal compressor and means for controlling the section of said diaphragm.

Indeed, the flow of refrigerant at the outlet of the diaphragm is dependent on the section thereof.

The turbine engine can also include computing means capable of determining:
the necessary speed of rotation of the screws of the supercharger or the necessary speed of rotation of the rotor of the centrifugal compressor, and/or
the necessary section of the diaphragm or the necessary position of the slide of the twin-screw supercharger,

as a function of
input parameters, in particular such as the temperature of the air outside the turbine engine, the characteristics of the compressor, the temperature of the oil at one point of the oil circuit, the speed of rotation of the rotor or the screws of the compressor, the section of the diaphragm or the position of the slide,
an oil temperature to be respected in the oil circuit, and/or
a mathematical model of the cooling means.

It should be noted that the characteristics of the compressor can be, in particular, its characteristic curve providing, for example, the pressure and/or the flow at the outlet of the compressor, as a function of the speed of rotation of the screws or of the rotor of said compressor.

The turbine engine preferably includes a secondary stream for passing a secondary flow coming from a fan, the first exchanger being arranged in the secondary stream.

Alternatively, the first exchanger is designed to exchange heat between the refrigerant and the ambient air outside the turbine engine.

According to one feature of the invention, the oil circuit can be designed to lubricate and/or cool elements of the turbine engine and/or a system, such as an electricity generator.

The invention likewise relates to a cooling system for cooling a fluid of a hot fluid circuit of an aircraft turbine engine, including a refrigerant circuit comprising:
a first heat exchanger forming a condenser, capable of exchanging heat between the refrigerant and the air,
a second heat exchanger forming an evaporator, capable of exchanging heat between the refrigerant and the fluid of the hot fluid circuit, and
a compressor mounted downstream from the second exchanger and upstream from the first exchanger, in the refrigerant flow direction, and a pressure reducer mounted downstream from the first exchanger and upstream from the second exchanger,
the cooling system comprising first regulator means capable of regulating the pressure of the refrigerant entering the first exchanger.

The fluid of the hot fluid circuit can be oil for lubricating systems of the turbine engine.

Alternatively, the fluid of the hot fluid circuit can be hot air collected from a compressor stage of the turbine engine.

The pressure reducer can be built into a duct of the refrigerant circuit, said duct connecting the first exchanger to the second exchanger, and the pressure reducer being formed by a local narrowing of the flow area of the duct.

Thus, the pressure reducer is not a member mounted on a duct, but instead can be formed by the actual duct.

The invention will be better understood and other details, characteristics, and advantages of the invention will appear on reading the following description given by way of non-limiting example and with reference to the accompanying drawings, in which:

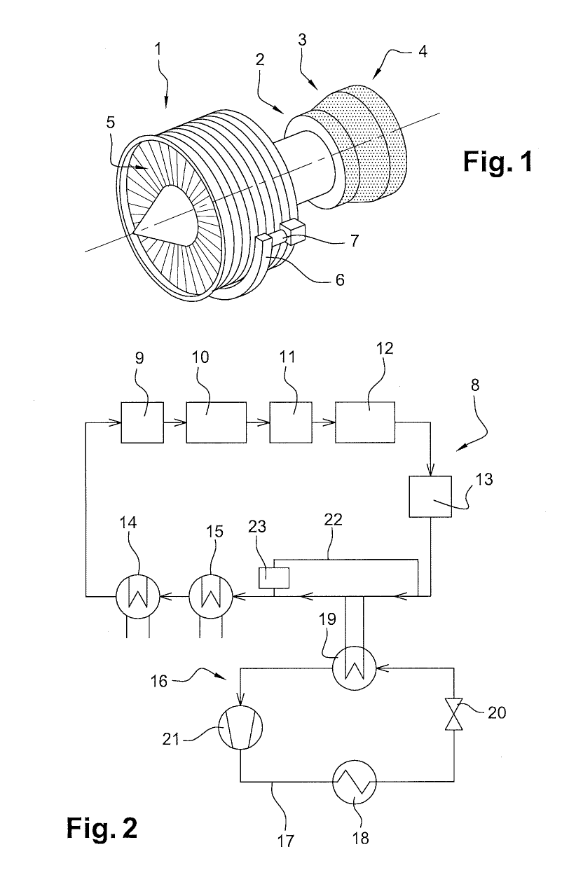

FIG. 1 is a perspective diagrammatic view of a turbine engine of the prior art;

FIG. 2 is a partial schematic depiction of an oil circuit and cooling means according to the prior art;

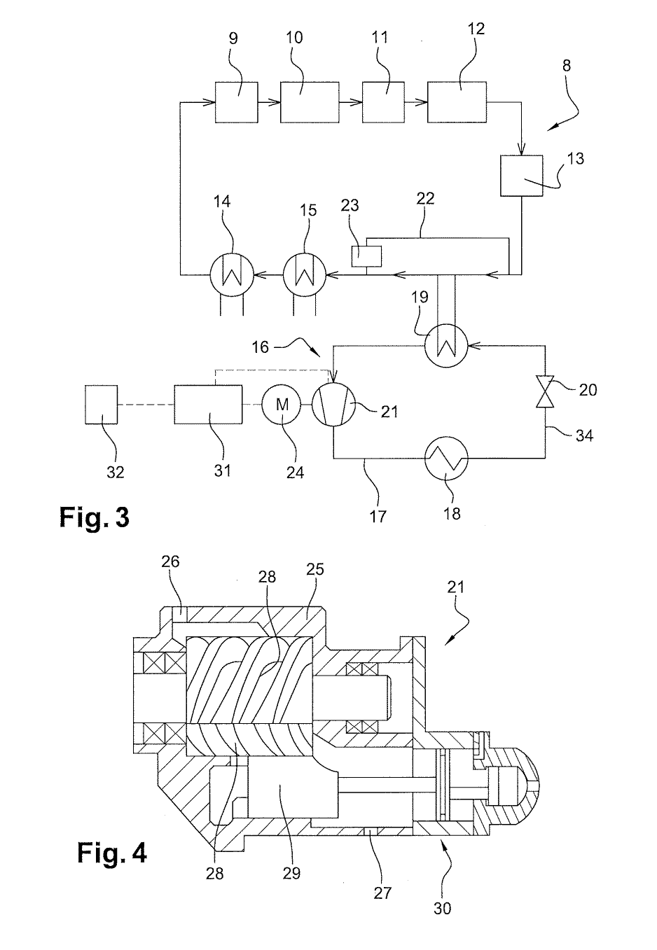

FIG. 3 is a view corresponding to FIG. 2, illustrating a first embodiment of the invention;

FIG. 4 is a diagrammatic section view of a twin-screw supercharger provided with a mobile slide;

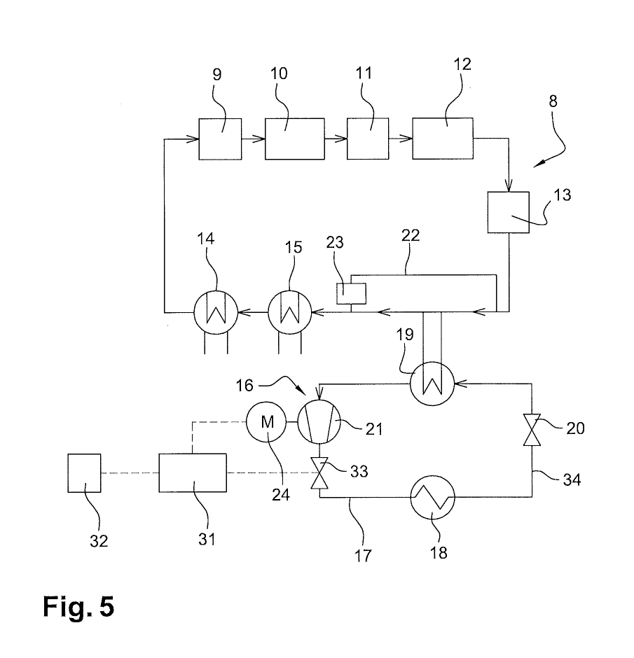

FIG. 5 is a view corresponding to FIG. 2, illustrating a second embodiment of the invention.

FIG. 1 shows a turbine engine 1 of the prior art comprising a combustion chamber 2, the combustion gases from the chamber driving a high-pressure turbine 3 and a low-pressure turbine 4. The high-pressure turbine 3 is coupled by a shaft to a high-pressure compressor arranged upstream from the combustion chamber 2 and supplying the latter with pressurised air. The low-pressure turbine 4 is coupled by another shaft to a fan wheel 5 arranged at the upstream end of the turbine engine 1.

A transmission gearbox 6, or accessory gearbox, is connected by a mechanical power take-off 7 to the shaft of the high-pressure turbine 3 and comprises a set of pinions for driving various systems of the turbine engine, such as pumps and generators, in particular electric. Other power transmissions can also be used.

FIG. 2 shows an oil circuit 8 of the turbine engine of FIG. 1.

The oil circuit 8 comprises, from the upstream end to the downstream end in the oil flow direction, various assemblies 9 using lubricating and/or cooling oil, scavenge pumps 10 allowing the recirculation of oil from the systems to a tank 11, supply pumps 12 and a filter 13.

In addition to the oil used for lubricating and cooling the turbine engine 1, in particular the bearings of turbine and compressor shafts, the general oil flow can comprise oil used for lubricating the accessory gearbox and for lubricating one or more electricity generators.

The oil circuit 8 comprises two heat exchangers mounted in series between the filter 13 and the assemblies 9, namely a main fuel/oil heat exchanger 14 and a secondary fuel/oil heat exchanger 15.

The device also includes a thermodynamic device 16 such as a heat pump. Said device 16 includes a refrigerant circuit 17 provided with a first heat exchanger 18 capable of exchanging heat between the refrigerant and the air and forming a condenser, a second heat exchanger 19 capable of exchanging heat between the refrigerant and the oil of the oil circuit 8 and forming an evaporator, a pressure reducer 20 mounted downstream from the first exchanger 18 and upstream from the second exchanger 19, in the refrigerant flow direction, and a compressor 21 mounted downstream from the second exchanger 19 and upstream from the first exchanger 18.

The first exchanger 18 is preferably arranged in the secondary stream for passing a secondary flow coming from the fan 5 of the turbine engine 1.

The oil circuit 8 also includes a line 22 mounted in the oil circuit 8 to bypass the second heat exchanger 19 and comprises an intake arranged between the outlet of the filter 13 and the intake of the second heat exchanger 19 and an outlet arranged between the outlet of said second heat exchanger 19 and the intake of the secondary fuel/oil heat exchanger 15. A hydraulic valve 23 is mounted in the bypass line 22 and controls the passage of the oil flow into the second exchanger 19 or through the bypass line 22.

During operation, when it is necessary to cool the oil of the circuit 8, the compressor 21 is started up. The evaporator 19 then makes it possible to vaporise the refrigerant by collecting heat from the oil. The compressor 21 makes it possible to increase the pressure and the temperature of the refrigerant in vapour phase before the latter passes through the condenser 18 where it releases heat into the air, by passing from the gaseous state to the liquid state. The refrigerant in liquid phase then passes through the pressure reducer 20, which reduces the pressure and the temperature thereof, before passing back through the evaporator 19.

It should also be noted that, in cold operating conditions, the valve 23 can be opened to allow oil to pass through the bypass line 22.

Such a device is generally characterised by the coefficient of performance (COP) thereof, which can be, for example, of the order of 5. This means that, for one unit of energy supplied to the compressor 21 (in the form of electric energy), five units of energy (in the form of heat) are collected by the oil and transferred to the air.

The high efficiency of such a system 16 thus makes it possible to reduce the size of the exchanger 18 between the air and the refrigerant, so as not to greatly affect the efficiency of the turbine engine.

In particular, the size of the exchanger 18 is limited by the fact that exchanges are possible between the refrigerant and the air with considerable temperature differences.

As indicated above, it appears to be necessary to further improve the overall efficiency of the assembly.

FIGS. 3 and 4 show a first embodiment of the invention in which the compressor 21 is a twin-screw supercharger actuated, for example, by an electric motor 24. The general structure of such a compressor 21 is known, in particular, from documents FR 2 501 799, EP 0 162 157 and U.S. Pat. No. 7,588,430 and will be described hereunder in reference to FIG. 4.

Said supercharger 21 includes a case 25 comprising a low-pressure refrigerant intake 26 and a high-pressure refrigerant outlet 27, said case 25 housing two rotors or rotary screws 28. The rotors 28 comprise helical teeth, one of said rotors 28 forming a male or driving rotor, actuated by an electric motor, the other rotor 28 forming a female rotor, driven or rotated by the rotation of the male rotor. The two rotors 28 have parallel axes and mesh with one another, defining therebetween and with the case a passage for circulating refrigerant which tends to narrow as it separates from the intake 26 of the case 25. Thus, the further the refrigerant progresses along said rotors 28, opposite the intake 26, the further said fluid is compressed. The length of the compression path traveled by the refrigerant can be adjusted by means of a mobile slide 29 moving in a sealed manner relative to said rotors 28. In other words, in reference to FIG. 4, the further to the left, i.e. towards the intake 26, the slide 29 is located, the lower the outlet pressure of the compressor 21 will be, and the further to the right, i.e. towards the outlet 27, the slide is located, the higher the outlet pressure of the compressor 21 will be.

The position of the slide 29 can be detected by a position sensor, for example such as an LVDT (Linear Variable Differential Transformer) sensor.

The slide 29 can be moved by any suitable means, for example such as an electric or hydraulic actuator 30.

Furthermore, as is known per se, the outlet flow of the compressor 21 is a function of the speed of rotation of the screws or rotors 28.

The turbine engine 1 also includes computing means 31, formed for example by a FADEC (Full Authority Digital Engine Control) computer, capable of determining the speed of rotation of the rotors 28 and the position of the slide 29 necessary to ensure adequate cooling of the corresponding circuit oil 8, as a function of all or part of the following elements 32:
input parameters, in particular such as the temperature of the air outside the turbine engine, the characteristics of the compressor 21, the temperature of the oil at one point of the oil circuit 8, the speed of rotation of the rotors or screws 28 of the compressor 21, and the position of the slide 29,
an oil temperature to be respected in the oil circuit 8, and/or
a mathematical model of the cooling means 16.

The invention thus makes it possible to adjust the pressure of the refrigerant at the intake of the condenser 18, via the position of the slide 29, and the refrigerant flow at the intake of the condenser 18, via the speed of rotation of the rotors 28. The actuator 30 of the slide 29 can be controlled by the computing means 31, or by separate computing means.

It is thus possible to adjust the power supplied to the compressor 21 to the cooling needs of the oil circuit 8, so as to improve the overall efficiency of the turbine engine 1.

FIG. 5 shows a second embodiment in which the compressor 21 is a centrifugal compressor including a rotor actuated, for example, by an electric motor 24. As a reminder, in the case of a centrifugal compressor, the outlet pressure of the compressor 21 is a function of the speed of rotation of said rotor.

Furthermore, in this embodiment, a variable-section diaphragm 33 is located between the outlet of the centrifugal compressor 21 and the intake of the condenser 18. The flow of refrigerant at the outlet of the diaphragm 33 thus can be regulated by varying the flow area of said diaphragm 33. Such a diaphragm is not, however, essential for carrying out the invention.

In this embodiment, the computing means 31, made up for example of the FADEC, are capable of determining the speed of rotation of the rotor of the centrifugal compressor 21 and the variable diaphragm section necessary for ensuring good cooling of the oil of the corresponding circuit, as a function of all or part of the following elements 32:
input parameters, in particular such as the temperature of the air outside the turbine engine, the characteristics of the compressor 21, the temperature of the oil at one point of the oil circuit 8, the speed of rotation of the rotor, and the section of the diaphragm 33,
an oil temperature to be respected in the oil circuit 8, and
a mathematical model of the cooling means 16.

The invention thus makes it possible to adjust the pressure of the refrigerant at the intake of the condenser 18, via the speed of rotation of the rotor of the compressor 21, and the refrigerant flow at the intake of the condenser 18, via the section of the diaphragm 33.

It is thus possible to adjust the power supplied to the compressor 21 to the cooling needs of the oil circuit 8, so as to improve the overall efficiency of the turbine engine 1.

It should be noted that the invention can also allow a reduction of the dimensions of the first heat exchanger 18, relative to the prior art, so as to reduce the drag of said exchanger 18 in the secondary stream, thus improving the efficiency of the turbine engine 1.

Furthermore, as indicated beforehand, the power to be supplied to the compressor 21 can be reduced by proportions which can be of the order of 70% relative to the prior art, in the majority of operating or flight phases.

It should be noted that the system may lack the bypass line 22 and the valve 23 (FIG. 2). Indeed, it is possible in particular to reduce the power supplied to the compressor. In particular, it is possible to switch off the compressor 21 under certain flight conditions, in particular during take-off in extremely cold weather.

Furthermore, the pressure reducer 20 can be built into the duct 34 of the refrigerant circuit 17, the pressure reducer 20 being, for example, formed by a local narrowing of the flow area of the duct 34.

1. A turbine engine comprising:
at least one oil circuit and cooling means for cooling oil of said oil circuit, the cooling means including a refrigerant circuit provided with a first heat exchanger for exchanging heat between a refrigerant and air and forming a condenser, a second heat exchanger for exchanging heat between the refrigerant and the oil of the oil circuit and forming an evaporator, a pressure reducer mounted downstream from the first heat exchanger and upstream from the second heat exchanger, in a refrigerant flow direction, and a compressor mounted downstream from the second heat exchanger and upstream from the first heat exchanger,
wherein the cooling means include first regulator means for regulating a pressure of the refrigerant entering the first heat exchanger.

2. The turbine engine according to claim 1, further comprising second regulator means for regulating a flow of refrigerant entering the first heat exchanger.

3. The turbine engine according to claim 1, wherein the compressor is a supercharger comprising rotors formed by rotary screws.

4. The turbine engine according to claim 3, wherein the first regulator means include a mobile slide having an adjustable position relative to the rotors of the compressor, the pressure of the refrigerant at an outlet of the compressor being dependent on the position of said slide, the first regulator means including means for controlling the position of said mobile slide.

5. The turbine engine according to claim 3, wherein the second regulator means include means for controlling a speed of rotation of the rotors of the compressor.

6. The turbine engine according to claim 1, wherein the compressor is a centrifugal compressor including a rotor, wherein a speed of rotation of the rotor determines a pressure of the refrigerant at an outlet of the compressor.

7. The turbine engine according to claim 6, wherein the first regulator means include means for controlling the speed of rotation of the rotor.

8. The turbine engine according to claim 6, wherein the second regulator means include a variable-section diaphragm located downstream from said centrifugal compressor, and means for controlling the variable-section diaphragm.

9. The turbine engine according to claim 5, wherein the means for controlling the speed of rotation of at least one rotor of the compressor comprise an electric motor controlled by a computer.

10. The turbine engine according to claim 2, comprising computing means for determining at least one of:
a necessary speed of rotation of the rotary screws of the supercharger;
a necessary speed of rotation of a rotor of a centrifugal compressor;
a necessary section of a variable-section diaphragm; and
a necessary position of a mobile slide of a twin-screw supercharger, as a function of at least one of:
at least one input parameter, including at least one of a temperature of the air outside the turbine engine, a characteristic of the compressor, a temperature of the oil at one point of the oil circuit, a speed of rotation of the rotor, a speed of rotation of the rotary screws of the compressor, a section of the variable-section diaphragm, and a position of the mobile slide;
an oil temperature of oil in the oil circuit; and
a mathematical model of the cooling means.

11. A cooling system for cooling a fluid of a hot fluid circuit of an aircraft turbine engine comprising:
a refrigerant circuit having:
a first heat exchanger forming a condenser for exchanging heat between a refrigerant and air;
a second heat exchanger forming an evaporator for exchanging heat between the refrigerant and the fluid of the hot-fluid circuit;
a compressor mounted downstream from the second heat exchanger and upstream from the first heat exchanger, in a refrigerant flow direction; and
a pressure reducer mounted downstream from the first heat exchanger and upstream from the second heat exchanger; and
first regulator means for regulating a pressure of the refrigerant entering the first heat exchanger, the fluid of the hot fluid circuit being oil for lubricating systems of the aircraft turbine engine.

12. (canceled)

13. (canceled)

14. The cooling system according to claim 11, wherein the pressure reducer is built into a duct of the refrigerant circuit, said duct connecting the first heat exchanger to the second heat exchanger, and wherein the pressure reducer is formed by a local narrowing of a flow area of the duct.
